(19) United States
(12) Patent Application Publication
(10) Pub. No.: US 2026/0044285 A1
(43) Pub. Date: Feb. 12, 2026

(54) MEMORY CONTROLLER, STORAGE DEVICE INCLUDING THE SAME, AND OPERATING METHOD THEREOF

(71) Applicant: Samsung Electronics Co., Ltd., Suwon-si (KR)

(72) Inventors: Kwanhyo KIM, Suwon-si (KR); Soyee Choi, Suwon-si (KR); Taec-Jun Kim, Suwon-si (KR)

(73) Assignee: Samsung Electronics Co., Ltd., Suwon-si (KR)

(21) Appl. No.: 19/050,579

(22) Filed: Feb. 11, 2025

(30) Foreign Application Priority Data
Aug. 7, 2024 (KR) 10-2024-0105150

(51) Int. Cl. G06F 3/06

(52) U.S. Cl. CPC G06F 3/0659; G06F 3/0613; G06F 3/0673

(57) ABSTRACT

A storage device is included. The storage device includes: a memory device including a plurality of planes, wherein each of the plurality of planes is provided in one of a plurality of banks of the memory device; and a memory controller configured to: receive, from a host, a plurality of jobs to be performed on the memory device, the plurality of jobs including a plane-level job to be performed in a plane from among the plurality of planes; determine, for each of the plurality of planes at a first time, a target bank from among the plurality of banks based on plane information associated with a job from among the plurality of jobs that is pending in the storage device; and transmit the job for the target bank to the memory device.

### CROSS-REFERENCE TO RELATED APPLICATION

This application claims priority to Korean Patent Application No. 10-2024-0105150, filed in the Korean Intellectual Property Office, on Aug. 7, 2024, the disclosure of which is hereby incorporated by reference in its entirety.

### BACKGROUND

### Field

The present disclosure relates to a memory controller, a storage device including the same, and an operating method thereof.

### Description of Related Art

Semiconductor memory devices may be largely divided into a volatile memory and a non-volatile memory. The volatile memory (e.g., dynamic random-access memory (DRAM) or static random-access memory (SRAM)) is a memory device that has fast read and write speeds, but loses stored data upon power cut off. On the other hand, the non-volatile memory can retain stored data even if power supply is cut off.

As the size of data for management with the semiconductor memory devices increases, the demand for high-performance and high-capacity memory devices is increasing. However, high-performance and high-capacity memory devices consume more power than before, requiring the introduction of technologies that can optimize or reduce power consumption.

### SUMMARY

One or more example embodiments provide a memory controller, a storage device including the same, and an operating method thereof.

An object to be achieved by the present disclosure is not limited thereto, and other objects not explicitly described herein may be clearly understood by those skilled in the art from the description of the present disclosure.

According to an aspect of an example embodiment, a storage device includes: a memory device including a plurality of planes, wherein each of the plurality of planes is provided in one of a plurality of banks of the memory device; and a memory controller configured to: receive, from a host, a plurality of jobs to be performed on the memory device, the plurality of jobs including a plane-level job to be performed in a plane from among the plurality of planes; determine, for each of the plurality of planes at a first time, a target bank from among the plurality of banks based on plane information associated with a job from among the plurality of jobs that is pending in the storage device; and transmit the job for the target bank to the memory device.

According to another aspect of an example embodiment, a memory controller, includes: a memory interface circuit connected to a memory device including a plurality of planes, wherein each of the plurality of planes is provided in one of a plurality of banks of the memory device; a host interface circuit connected to a host and configured to receive, from the host, a plurality of jobs to be performed on the memory device, the plurality of jobs including a plane-level job to be performed in a plane within the memory device; and a processor connected to the memory interface circuit and the host interface circuit, wherein the processor is configured to: determine, for each of the plurality of planes at a specific time, one of the plurality of banks to be a target bank based on plane information associated with a job pending in the memory device or the memory controller; and transmit, among the plurality of jobs that are waiting in the memory controller, a waiting job for the target bank to the memory device through the memory interface circuit.

According to another aspect of an example embodiment, a method for operating a storage device is provided. The method is performed by a memory controller and includes: receiving a plurality of jobs to be performed on a memory device, the plurality of jobs including a plane-level job to be performed in a plane from among a plurality of planes of the memory device, wherein each of the plurality of planes is included in one of a plurality of banks of the memory device; determining, for each of the plurality of planes at a specific time, one of the plurality of banks to be a target bank based on plane information associated with a job pending in at least one of the memory device or the memory controller; and transmitting, among the plurality of jobs that are waiting in the memory controller, a waiting job for the target bank to the memory device.

According to one or more example embodiments, by determining a bank, which is expected to have a high degree of overlap in the job performance time of each of the planes, to be the target bank, and transmitting the job to the determined target bank, the power consumption of the that bank may be optimized and reduced compared to when there is no overlap or a low degree of overlap in the job performance time of each of the planes.

According to one or more example embodiments, even if a job is transmitted to the target bank, if it is expected that there is no overlap or a low degree of overlap in the job performance time of each of the planes, the degree of overlap in the job performance time of each of the planes may be improved by re-determining the target bank based on the following time.

Various and beneficial advantages and effects of the present disclosure are not limited to those described above, and can be more easily understood in the course of describing specific aspects of the present disclosure.

### BRIEF DESCRIPTION OF DRAWINGS

The above and other objects, features and advantages of the present disclosure will be more apparent from the following description of example embodiments, taken in conjunction with the accompanying drawings, in which:

FIG. 1 is a block diagram illustrating a storage device according to an example embodiment;

FIG. 2 is a block diagram illustrating the memory device illustrated in FIG. 1 according to an example embodiment;

FIG. 3 is a block diagram schematically illustrating a structure of a memory device according to an example embodiment;

FIG. 4 is a diagram illustrating a plurality of planes in the bank of FIG. 1 according to an example embodiment;

FIG. 5 is a circuit diagram illustrating structure of a memory block in the plane of FIG. 4 according to an example embodiment;

FIG. 6A is a diagram illustrating a method for operating a storage device according to an example embodiment;

FIG. 6B is a diagram illustrating a job queue and job data of a memory controller according to an example embodiment;

FIG. 7 is a diagram illustrating a memory controller according to an example embodiment;

FIG. 8A is a block diagram illustrating data stored in the volatile memory of FIG. 7 according to an example embodiment;

FIG. 8B is a diagram illustrating the first bitmap and the second bitmap of FIG. 8A according to an example embodiment;

FIG. 8C is a diagram illustrating the third bitmap and the remaining time information of FIG. 8A according to an example embodiment;

FIG. 9 is a diagram illustrating the operation S630 of FIG. 6 according to an example embodiment;

FIG. 10A is a diagram illustrating sub-operations of the operation S635 of FIG. 9 according to an example embodiment;

FIG. 10B is a diagram visualizing remaining times of running jobs in the planes of some banks according to an example embodiment;

FIG. 11A is a diagram illustrating sub-operations of the operation S635 of FIG. 9 according to according to an example embodiment;

FIG. 11B is a diagram visualizing remaining times of running jobs in the planes of some banks and expected performance times of waiting jobs according to an example embodiment;

FIG. 12A is a flowchart provided to explain the operation S630 of FIG. 9 according to an example embodiment;

FIG. 12B is a flowchart provided to explain a modified example of the operation S630 of FIG. 9 according to an example embodiment;

FIG. 13A is a diagram illustrating amounts of current consumed when there is one plane performing a job in each time unit in a single bank according to an example embodiment; and

FIG. 13B is a diagram illustrating the amounts of current consumed when there are four planes performing a job in each time unit in a single bank according to an example embodiment.

### DETAILED DESCRIPTION

Hereinafter, example embodiments are described in detail with reference to the accompanying drawings. Like components are denoted by like reference numerals throughout the specification, and repeated descriptions thereof are omitted. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

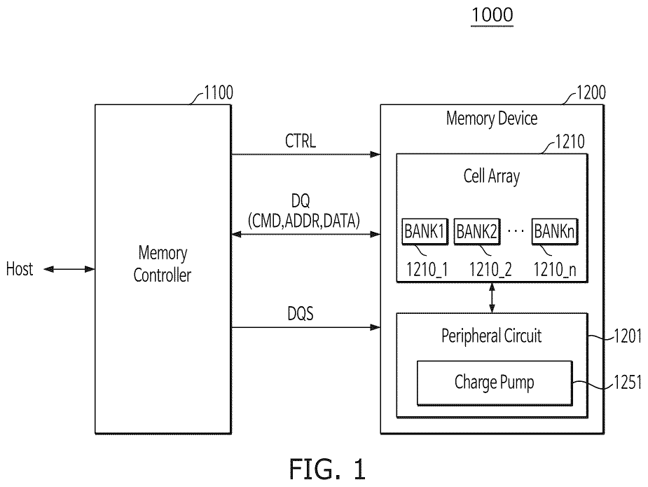

FIG. 1 is a block diagram illustrating a storage device according to an example embodiment. Referring to FIG. 1, a storage device 1000 may include a memory controller 1100 and a memory device 1200 (e.g., a non-volatile memory device (NVM)). The storage device 1000 may store data in the memory device 1200 under the control of the memory controller 1100. For example, each of the memory controller 1100 and the memory device 1200 may be provided as one chip, one package, or one module. Alternatively, the memory controller 1100 and the memory device 1200 may be formed as one chip, one package, or one module to be provided as a storage, such as an embedded memory, a memory card, a memory stick or a solid state drive (SSD), etc.

The memory controller 1100 may perform an access operation of writing data to the memory device 1200 or reading data stored in the memory device 1200 according to a request from a host. The memory controller 1100 may generate a command CMD, an address ADDR, and a control signal CTRL for accessing the memory device 1200.

The memory controller 1100 may transmit the control signal CTRL to the memory device 1200. For example, the control signal CTRL may include a chip enable signal CE, a command latch enable signal CLE, an address latch enable signal ALE, a write enable signal WE, a read enable signal RE, etc.

The memory controller 1100 may transmit the command CMD, the address ADDR, and data DATA to the memory device 1200 through a data signal DQ. The memory device 1200 may identify (or capture), based on a data strobe signal DQS, the data DATA provided through the data signal DQ. The memory device 1200 may store the identified data DATA based on the received command CMD and address ADDR.

The memory device 1200 may include a volatile memory or a non-volatile memory, such as a random-access memory (RAM), a static RAM (SRAM), a dynamic RAM (DRAM), a synchronous DRAM (SDRAM), a read only memory (ROM), a programmable ROM (PROM), an electrically programmable ROM (EPROM), an electrically erasable and programmable ROM (EEPROM), a magnetic RAM (MRAM), a spin-transfer torque MRAM, a conductive bridging RAM (CBRAM), a ferroelectric RAM (FeRAM), a phase RAM (PRAM), a resistive RAM, etc.

The memory device 1200 may include a cell array 1210 and a peripheral circuit 1201. The cell array 1210 may include a plurality of banks 1210_1 to 1210_n (where, n is any natural number). The cell array 1210 may include a plurality of planes, and each of the plurality of planes may be included in one of the plurality of banks 1210_1 to 1210_n of the memory device.

On a design layout structure, the cell array 1210 may be located on a side of, or above the peripheral circuit 1201. This structure may be referred to as a cell on peripheral (COP) structure when the cell array 1210 is located above the peripheral circuit 1201. On the other hand, the cell array 1210 may be manufactured as a chip separate from the peripheral circuit 1201. An upper chip including the cell array 1210 and a lower chip including the peripheral circuit 1201 may be connected to each other by bonding. This structure may be referred to as a chip to chip (C2C) structure.

The peripheral circuit 1201 may include analog and/or digital circuits used to store data in the cell array 1210 or to read or erase data stored in the cell array 1210. The peripheral circuit 1201 may receive external power PWR from the memory controller 1100 and generate internal power (e.g., VCC) of various levels.

The peripheral circuit 1201 may store the data in the cell array 1210 according to the control of the control signal CTRL. In addition, the peripheral circuit 1201 may read the data stored in the cell array 1210, provide the data to the memory controller 1100, or erase the data stored in the cell array 1210.

A charge pump 1251 may generate a voltage that may be used during read, erase, or write operations of the cell array. For example, the charge pump 1251 may step up the input voltage to a target level voltage in response to a clock signal. A word line voltage generated by the charge pump 1251 may be transferred to a memory block of each of the plurality of banks 1210_1 to 1210_n.

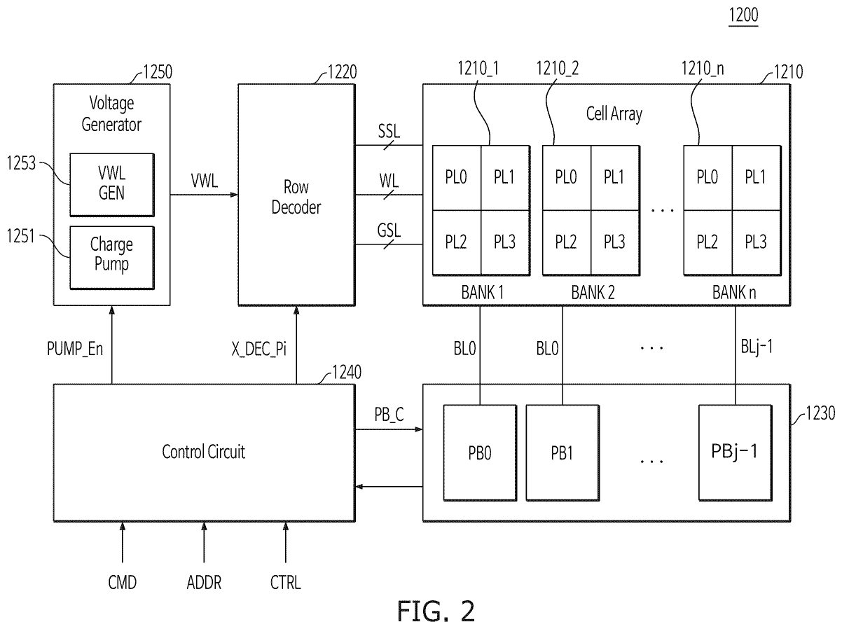

FIG. 2 is a block diagram illustrating the memory device illustrated in FIG. 1 according to an example embodiment. Referring to FIG. 2, the memory device 1200 may include the cell array 1210, a row decoder (i.e., a row decoder circuit) 1220, a page buffer circuit 1230, a control circuit 1240, and a voltage generator (i.e., a voltage generation circuit) 1250.

Each of the plurality of banks 1210_1 to 1210_n may include a plurality of planes PL0, PL1, PL2, and PL3. Although FIG. 2 illustrates the plurality of banks 1210_1 to 1210_n including four planes, this is for ease of description and aspects are not limited thereto.

Each of the plurality of planes PL0, PL1, PL2, and PL3 may include a plurality of memory blocks. For example, each of the plurality of memory blocks may have a vertical three-dimensional (3D) structure. Each memory block may include a plurality of memory cells. For example, each memory block may include a plurality of pages, and each page may include a plurality of memory cells. Each memory cell may store multi-bit data. Each memory block may be a unit of erasure, and each page may be a unit of read or write.

The memory controller (e.g., the memory controller 1100 of FIG. 1) may provide a plane independent command (PIC) (e.g., plane independent read (PIR)) to the memory device 1200. For example, the memory controller may receive, from the host, a plane-level job to be performed in a plane within the memory device 1200 and transmit the received job to the memory device 1200. The plane-level job may be a read job, a write job, or an erase job, and may include one or more PICS.

Additionally, the memory controller 1100 may provide a multi-plane command to the memory device 1200. For example, the memory controller 1100 may provide a multi-plane read command for reading data from a plurality of planes for a selected row.

The cell array 1210 may be formed in a direction perpendicular to the substrate. A gate electrode layer and an insulation layer may be alternately deposited on the substrate. Each memory block may be connected to a string select line SSL, a plurality of word lines, and a ground select line GSL. The number of stacked gate electrode films with the word lines of the cell array 1210 formed thereon may increase. Therefore, the capacity of the charge pump 1251 for driving the word line may increase along with an increase in the number of word lines integrated on the same chip area. However, applying the COP or C2C technology may involve a substantial reduction in the area of the peripheral region where the peripheral circuit (e.g., the peripheral circuit 1201 of FIG. 1) is integrated.

The row decoder 1220 may select a word line of the cell array 1210 in response to the row address ADDR. The row decoder 1220 may provide the word line voltage VWL provided from the voltage generator 1250 to the cell array 1210 through the select lines SSL and GSL and the word lines WL. The row decoder 1220 may select a word line during a program or read operation. The row decoder 1220 may provide a program voltage or a read voltage to the selected word line.

The page buffer circuit 1230 may be connected to the cell array 1210 through bit lines BL0 to BLj−1 (where, j is a positive integer). In response to a page buffer control signal PB_C provided from the control circuit 1240, the page buffer circuit 1230 may precharge or sense the bit lines BL0 to BLj−1 connected to the memory cells. The page buffer circuit 1230 may include a plurality of page buffers PBO to PBj−1. The plurality of page buffers PBO to PBj−1 may be connected to the memory cells through the plurality of bit lines BL0 to BLj−1, respectively. The page buffer circuit 1230 may operate as a write driver and/or a sense amplifier depending on an operation mode. For example, during a write operation (program operation), the page buffer circuit 1230 may apply, to a selected bit line, a bit line voltage corresponding to data to be programmed. During a read operation, the page buffer circuit 1230 may sense data stored in memory cells by sensing a current or voltage of a selected bit line.

The control circuit 1240 may control various operations in the memory device 1200 according to modes. The control circuit 1240 may perform write, read, erase operations, etc. on the cell array 1210 in response to a control signal CTRL, a command CMD, and/or an address ADDR. For example, for a program operation, the control circuit 1240 may generate a pump enable signal PUMP_En, a page buffer control signal PB_C, etc. The control circuit 1240 may control the voltage generator 1250 to generate voltages used for the write, read, erase operations by providing the pump enable signal PUMP_En thereto.

In response to the pump enable signal PUMP_En from the control circuit 1240, the voltage generator 1250 may generate a word line voltage VWL used to read or write data. The word line voltage VWL may include a selected word line sWL or an unselected word line uWL. The word line voltage VWL may be provided to the row decoder 1220. To this end, the voltage generator 1250 may include a charge pump 1251 and a word line voltage generator 1253. The word line voltage generator 1253 may generate a word line voltage which is provided during a program operation, or a word line voltage which is provided during a read operation.

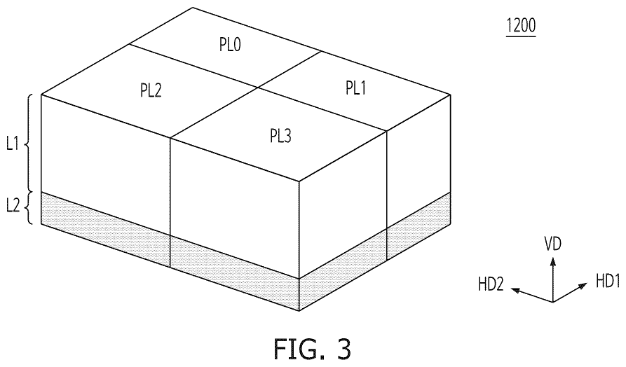

FIG. 3 is a block diagram schematically illustrating a structure of a memory device according to an example embodiment. Referring to FIG. 3, the memory device 1200 may include a first semiconductor layer L1 and a second semiconductor layer L2, and the first semiconductor layer L1 may be stacked in a vertical direction VD with respect to the second semiconductor layer L2. Specifically, the second semiconductor layer L2 may be disposed below the first semiconductor layer L1 in the vertical direction VD, and thus, the second semiconductor layer L2 may be disposed close to the substrate. Although FIG. 3 illustrates the memory device 1200 including four planes, this is for ease of description and aspects are not limited thereto.

The plurality of planes PL0 to PL3 may be formed in the first semiconductor layer L1, and the peripheral circuit 1201 corresponding to the row decoder 1220, the page buffer circuit 1230, the control circuit 1240, and the voltage generator 1250 of FIG. 2 may be formed in the second semiconductor layer L2.

The second semiconductor layer L2 may include a substrate, and the peripheral circuits 1220, 1230, 1240, and 1250 of FIG. 2 may be formed in the second semiconductor layer L2 by forming transistors and metal patterns for wiring the transistors on the substrate. After the peripheral circuits 1220, 1230, 1240, and 1250 of FIG. 2 are formed in the second semiconductor layer L2, the first semiconductor layer L1 including the cell array 1210 of FIG. 2 may be formed, and metal patterns may be formed to electrically connect the word lines WL and the bit lines BL of the cell array 1210 to the peripheral circuits 1220, 1230, 1240, and 1250 formed in the second semiconductor layer L2.

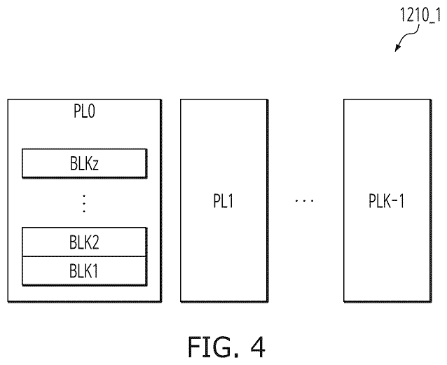

FIG. 4 is a diagram illustrating a plurality of planes PL0 to PLK-1 in the bank 1210_1 of FIG. 1 according to an example embodiment. Referring to FIG. 4, any of the plurality of banks 1210_1 to 1210_n of FIG. 1 may include the plurality of planes PL0 to PLK-1 (where, K is a natural number of 2 or more). Each of the plurality of planes PL0 to PLK-1 may include a plurality of memory blocks BLK1 to BLKz (where, z is a natural number of 2 or more).

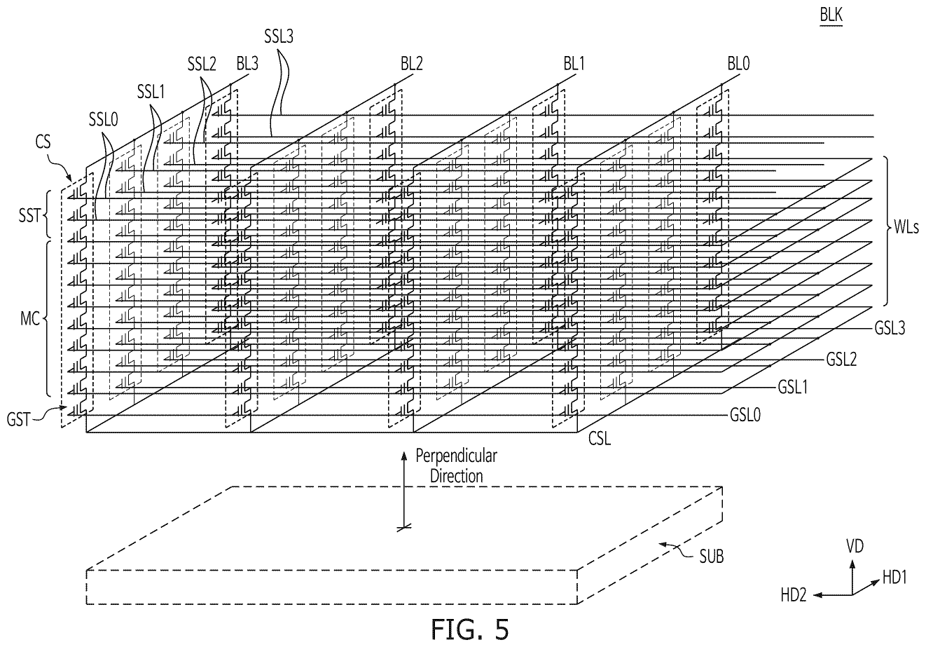

FIG. 5 is a circuit diagram illustrating an example structure of the memory block BLK in the plane of FIG. 4 according to an example embodiment. Referring to FIG. 5, cell strings CS may be formed between bit lines BL0, BL1, BL2, and BL3 and a common source line CSL to form the memory block BLK. The cell strings CS may include a string select transistor SST, a plurality of memory cells MC, and a ground select transistor GST connected in series. The transistors SST and GST and the memory cells MC included in each cell string may form a stacked structure along a vertical direction on a substrate. The bit lines BL0, BL1, BL2, and BL3 may extend in a first horizontal direction HD1, and the word lines WL may extend in a second horizontal direction HD2.

The string select transistor SST may be connected to corresponding string select lines SSLO to SSL3. The memory cells MC may be connected to corresponding word lines WL, respectively. The ground select transistor GST may be connected to corresponding ground select lines GSLO to GSL3. The string select transistor SST may be connected to a corresponding bit line, and the ground select transistor GST may be connected to the common source line CSL.

Each of the cell strings CS may include a ground select transistor GST. The ground select transistors included in the cell strings CS may be controlled by the ground select line GSL. However, example embodiments are not limited thereto, and for example, cell strings corresponding to each row may be controlled by different ground select lines.

In the above, a circuit structure of memory cells included in one memory block BLK has been briefly described. It is to be noted that the circuit structure of the illustrated memory block is only a simplified structure for ease of description, and an actual memory block is not limited to the illustrated example. That is, it will be readily understood that more semiconductor layers, bit lines, and string select lines SSL can be included in one physical block.

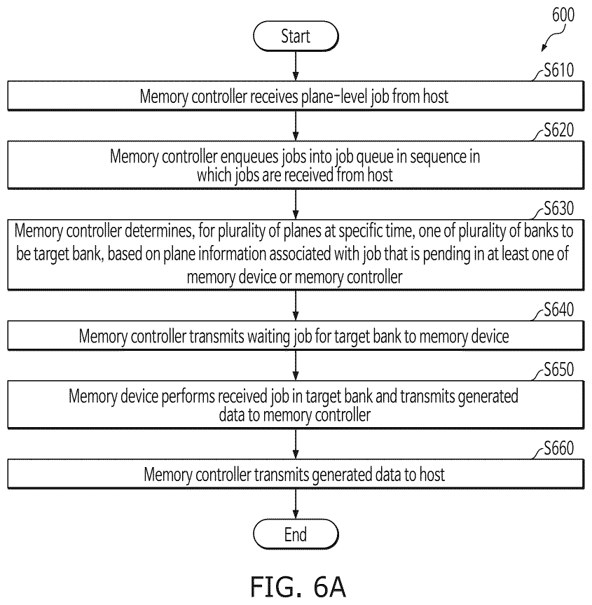

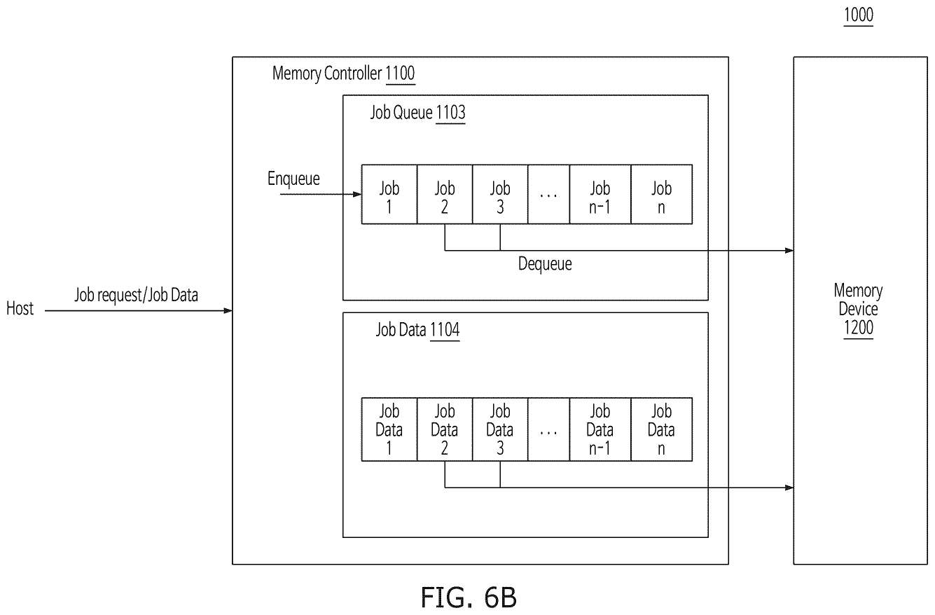

FIG. 6A is a diagram illustrating a method 600 for operating a storage device according to an example embodiment, and FIG. 6B is a diagram illustrating a job queue 1103 and job data 1104 of the memory controller 1100 according to an example embodiment. Referring to FIGS. 6A and 6B, the method 600 of FIG. 6A may be performed in the memory controller 1100.

The memory controller 1100 may receive, from the host, a plane-level job to be performed in a plane within the memory device 1200, at S610. For example, the host may transmit a job request to the memory controller 1100, and the memory controller 1100 may receive a plane-level job in the form of a descriptor according to the job request. The memory controller 1100 may also receive, from the host, the job data 1104 required for performing the job.

The memory controller 1100 may enqueue the jobs into the job queue 1103 in the order in which they are received from the host, at S620. The job queue 1103 may operate in a priority queue scheme.

The memory controller 1100 may determine, for the plurality of planes at a specific time, one of the plurality of banks to be a target bank, based on plane information associated with a job that is pending in at least one of the memory device or the memory controller, at S630.

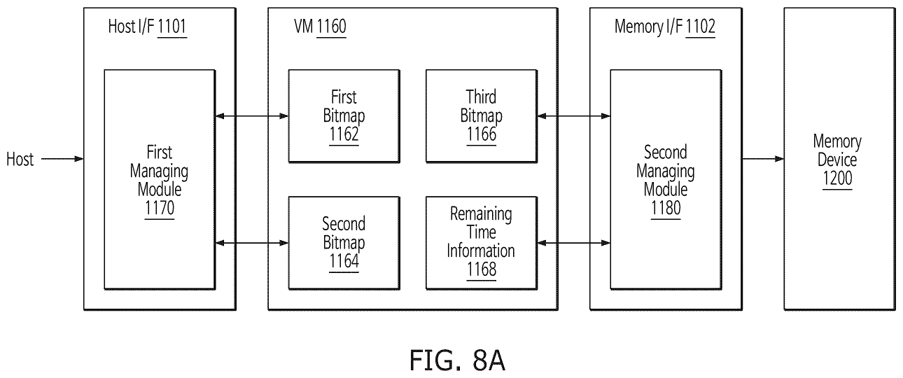

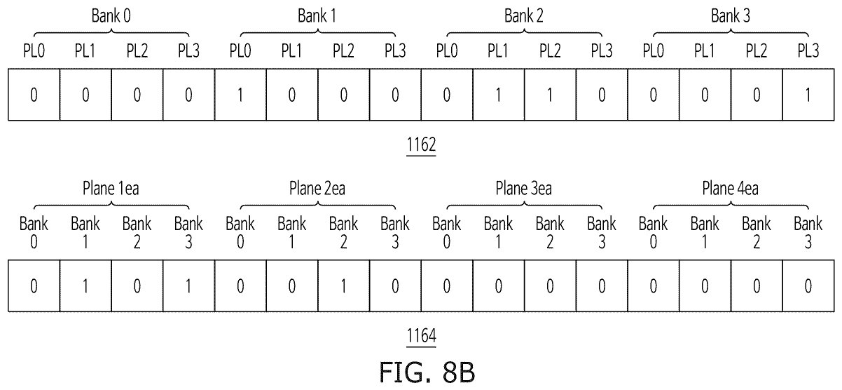

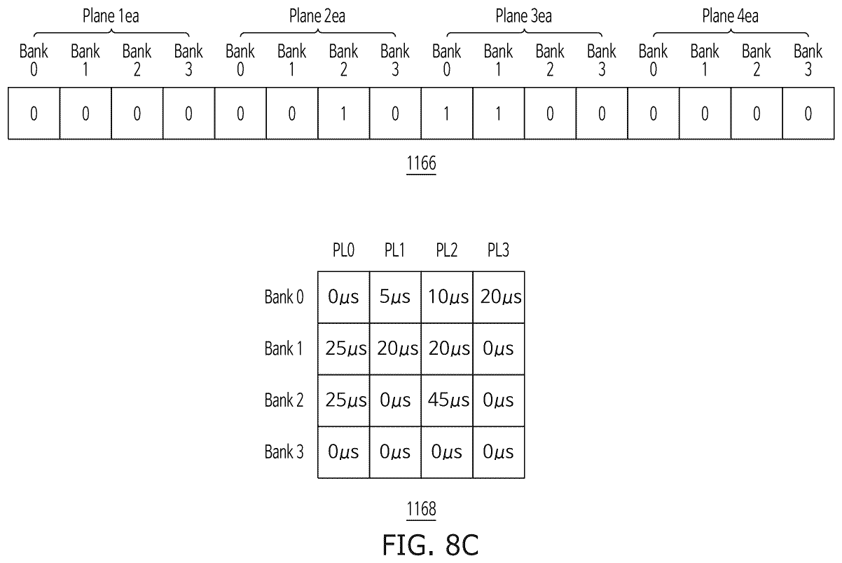

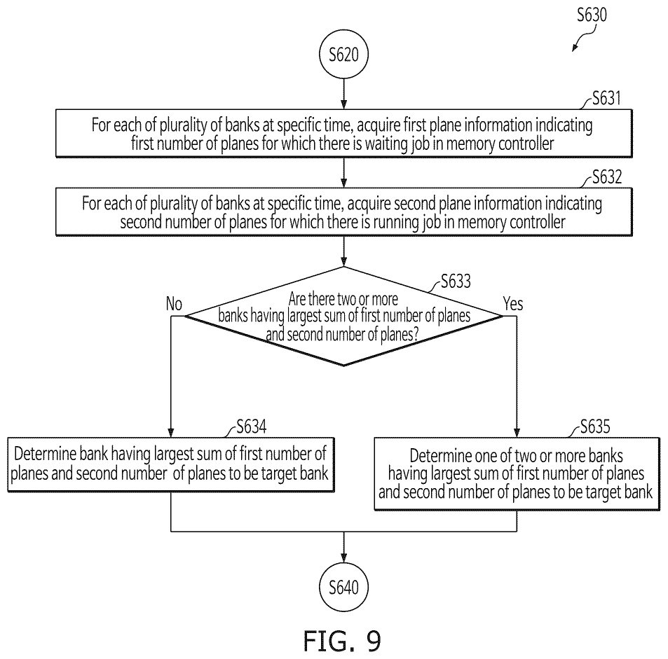

The plane information may include, for each of the plurality of banks of the memory device 1200, first plane information including a first number of planes for which there is a waiting job in the memory controller 1100. In addition, the plane information may include, for each of the plurality of banks of the memory device 1200, second plane information including a second number of planes for which there is a running job in the memory device 1200. The first plane information and the second plane information will be described in detail below with reference to FIGS. 8A to 8C. Furthermore, the specific process of determining a target bank using the plane information will be described in detail elsewhere below with reference to FIGS. 9 to 11B.

Among a plurality of jobs received from the host and waiting in the memory controller 1100, the memory controller 1100 may transmit a waiting job for the target bank determined at S630 to the memory device 1200, at S640. That is, the memory controller 1100 may transmit a waiting job for one or more planes of the determined target bank to the memory device 1200. For example, referring to FIG. 6B, Job 2 and Job 3, which are in the job queue 1103 for the determined target bank (i.e., are waiting jobs), may be dequeued from the job queue 1103 and transmitted to the memory device 1200. Additionally, among the job data 1104, Job Data 2 and Job Data 3 required to perform Job 2 and Job 3 may also be transmitted from the memory controller 1100 to the memory device 1200.

The memory controller 1100 may transmit one job per each plane of the determined target bank, or may transmit a plurality of jobs. For example, the memory controller 1100 may transmit, among the plurality of waiting jobs for a specific plane, a job received for the first time by the memory controller 1100 to the memory device 1200, or may transmit two or more jobs to the memory device 1200.

In response to receiving a job from the memory controller 1100, the memory device 1200 may perform the received job in the target bank and transmit the generated data to the memory controller 1100, at S650.

The memory controller 1100 may transmit the data received from the memory device 1200 to the host, at S660.

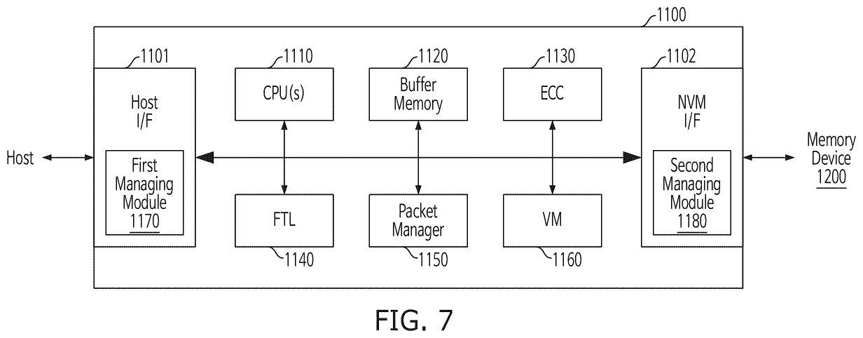

FIG. 7 is a diagram illustrating the memory controller 1100. Referring to FIG. 7, the memory controller 1100 may include a host interface circuit 1101, a memory interface circuit 1102, at least one processor 1110, a buffer memory 1120, an error correction circuit 1130, a flash translation layer manager (i.e., flash translation layer manager circuit) 1140, a packet manager (i.e., packet manager circuit) 1150, and a volatile memory 1160.

The host interface circuit 1101 may be implemented to transmit and receive packets to and from the host. A packet transmitted from the host to the host interface circuit 1101 may include a job, a command, and/or data (e.g., job data) to be used in the memory device 1200. A packet transmitted from the host interface circuit 1101 to the host may include a response to a job and/or a command and/or data read from the memory device 1200.

The memory interface circuit 1102 may transmit data to be written to the memory device 1200 or may receive data read from the memory device 1200. This memory interface circuit 1102 may be implemented to comply with standard conventions such as JDEC Toggle, ONFI, etc.

The host interface circuit 1101 and the memory interface circuit 1102 may include managing modules 1170 and 1180. The managing modules 1170 and 1180 may be implemented using hardware, and may be controlled according to using computer-readable instructions. The managing modules 1170 and 1180 may generate, update, transmit, and delete data (e.g., plane information, bitmap, etc.) stored in the volatile memory 1160. In some example embodiments, the managing modules 1170 and 1180 may be separate modules in the memory controller 1100 that are not included in the host interface circuit 1101 and the memory interface circuit 1102.

The processor 1110 (or processor core) may control overall operations (e.g., write operations, read operations, file system management operations) on the memory device 1200. In some aspects, the processor 1110 may be used to determine a target bank. For example, the processor 1110 may control the operation S630 of FIG. 6A, etc.

The buffer memory 1120 may temporarily store data to be written in the memory device 1200 or data read from the memory device 1200. Although the buffer memory 1120 is illustrated as being provided in the memory controller 1100, aspects are not limited thereto, and the buffer memory 1120 may be disposed outside the memory controller 1100.

The error correction circuit 1130 may receive a codeword from the memory device 1200 and perform error correction decoding on the received codeword. Due to deterioration of memory cells in the cell array within the memory device 1200, noise related to the memory operation, etc., the codeword received by the error correction circuit 1130 from the memory device 1200 may include a fail bit. The error correction circuit 1130 may correct an error in the codeword and provide the host with data whose integrity is ensured.

The flash translation layer manager 1140 may perform several functions such as address mapping, wear-leveling, garbage collection. The address mapping is an operation of changing a logical address received from the host into a physical address for use in actually storing data in the memory device 1200. The wear-leveling is a technology for preventing excessive deterioration of a specific block by allowing the blocks in the memory device 1200 to be used evenly, and, for example, may be implemented through a firmware technology that balances erase counts of physical blocks. The garbage collection is a technology for securing usable capacity in the memory device 1200 by copying valid data of a block to a new block and erasing the existing block.

The packet manager 1150 may generate a packet according to the protocol of the interface negotiated with the host or parse various information from a packet received from the host.

FIG. 8A is a block diagram illustrating data stored in the volatile memory 1160 of FIG. 7 according to an example embodiment, FIG. 8B is a diagram illustrating an example of a first bitmap 1162 and a second bitmap 1164 of FIG. 8A according to an example embodiment, and FIG. 8C is a diagram illustrating an example of a third bitmap 1166 and remaining time information 1168 of FIG. 8A according to an example embodiment. In FIGS. 8A to 8C, for ease of description, the memory device 1200 is illustrated and described as including four banks (Bank 0 to Bank 3), and each of the banks including four planes PL0 to PL3. However, the first bitmap 1162, the second bitmap 1164, the third bitmap 1166, and the remaining time information 1168 may differ in structure and format depending on various implementation methods as well as the number of banks and/or planes included in the memory device 1200, and example embodiments are not limited to those shown in FIGS. 8A to 8C.

Referring to FIG. 8B, for a plurality of planes (PL0 to PL3 of each of Banks 0 to 3) in the memory device 1200, the first bitmap 1162 may be a bitmap indicating a portion of the first plane information, and may indicate one or more planes for which there is a waiting job in the memory controller 1100. The waiting job for the plurality of planes (PL0 to PL3 of each of Banks 0 to 3) may refer to a job that has been enqueued into the job queue 1103 of FIG. 6B but not dequeued. For example, each of the plurality of bits in the first bitmap 1162 corresponds to one of the planes of the memory device 1200, and the example of the first bitmap 1162 illustrated in FIG. 8B may indicate that there is one or more waiting jobs for PL0 of Bank 1, PL1 and PL2 of Bank 2, and PL3 of Bank 3.

For each of the plurality of banks (Banks 0 to 3), the second bitmap 1164 may indicate a portion of the first plane information regarding the first number of planes for which there is a waiting job in the memory controller 1100. For example, the second bitmap 1164 may include multiple plane areas, each plane area including a bit for a corresponding bank. Plane lea area of the second bitmap 1164 may be used to indicate banks with one plane area with a waiting job. Plane 2ea area of the second bitmap 1164 may be used to indicate banks with two plane areas with a waiting job. Plane 3ea area of the second bitmap 1164 may be used to indicate banks with three plane areas with a waiting job. Plane 4ea area of the second bitmap 1164 may be used to indicate banks with four plane areas with a waiting job.

The memory controller 1100 (or the first managing module 1170) may use the first bitmap 1162 to calculate the second bitmap 1164. For example, referring to the first bitmap 1162, in the “Plane lea” area of the second bitmap 1164, the bits corresponding to Bank 1 and Bank 3 may be set to a first bit (e.g., “1”) because there is a waiting job for one plane in the Bank 1 and a waiting job for one plane in the Bank 3. Similarly, in a “Plane 2ea” area of the second bitmap 1164, the bit corresponding to Bank 2 may be set to the first bit. On the other hand, because there are no waiting jobs for planes of Bank 0, all bits corresponding to Bank 0 of the second bitmap 1164 may be set to a second bit (e.g., “0”) which is the opposite of the first bit.

Referring to FIGS. 8A and 8B, in response to receiving a job from the host, the memory controller 1100 (or the first managing module 1170) may update at least a part of the first bitmap 1162 and at least a part of the second bitmap 1164 associated with the plane to perform the received job. For example, in response to the memory controller 1100 (or the host interface circuit 1101) receiving a job for PL0 of Bank 0, the first managing module 1170 may update the first bit (PL0 of Bank 0) of the first bitmap 1162 associated with the same to “1”. Additionally, the first managing module 1170 may update the first bit (Bank 0 of Plane lea) of the second bitmap 1164 to “1”, indicating that one or more jobs are waiting for one plane of Bank 0.

In response to the memory controller 1100 transmitting the waiting job to the memory device 1200, the memory controller 1100 (or the first managing module 1170) may update at least a part of the first bitmap 1162 and at least a part of the second bitmap 1164 associated with the plane to perform the transmitted job. For example, in response to the memory controller 1100 (or the memory interface circuit 1102) transmitting a job for PL3 of Bank 3 to the memory device 1200, the first managing module 1170 may update the last bit (PL3 of Bank 3) of the first bitmap 1162 associated with the same to “0”. Additionally, the first managing module 1170 may update the fourth bit (Bank 3 of Plane lea) of the second bitmap 1164 to “0”, indicating that there are no waiting jobs for Bank 3.

Referring to FIG. 8C, for each of the plurality of banks (Banks 0 to 3), the third bitmap 1166 may indicate a portion of the second plane information regarding the second number of planes for which there is a running job in the memory device 1200. The running job for the plurality of planes (PL0 to PL3 of each of Banks 0 to 3) may refer to a job that was dequeued from the job queue 1103 of FIG. 6B and transmitted to the memory device 1200, but not finished in the memory device 1200. For example, the third bitmap 1166 may include multiple plane areas, each plane area including a bit for a corresponding bank. Plane lea area of the third bitmap 1166 may be used to indicate banks with one plane area with a running job. Plane 2ea area of the third bitmap 1166 may be used to indicate banks with two plane areas with a running job. Plane 3ea area of the third bitmap 1166 may be used to indicate banks with three plane areas with a running job. Plane 4ea area of the third bitmap 1166 may be used to indicate banks with four plane areas with a running job. For example, the example of the third bitmap 1166 illustrated in FIG. 8C may indicate that there are three planes for which there is a running job in Bank 0 and Bank 1, two planes for which there is a running job in Bank 2, and no planes for which there is a running job in Bank 3.

Referring to FIGS. 8A and 8C, in response to transmitting a specific job to the memory device 1200 (or in response to the memory device 1200 starting executing that job), the memory controller 1100 (or the second managing module 1180) may update a part of the third bitmap 1166 associated with the plane performing the transmitted job. For example, in response to the memory controller 1100 (or the memory interface circuit 1102) transmitting a specific job for PL0 of Bank 3 to the memory device 1200, the second managing module 1180 may update the bit (Bank 3 of Plane lea) of the third bitmap 1166 associated with the same to “1”.

The memory controller 1100 (or the volatile memory 1160) may store the remaining time information 1168 indicating a remaining time until a running job in each of the plurality of planes is completed. In response to the memory controller 1100 (or the memory interface circuit 1102) transmitting a specific job to the memory device, the memory controller 1100 (or the second managing module 1180) may update the remaining time information 1168 by increasing the remaining time of the plane performing the transmitted job by an expected performance time of the transmitted job. For example, in response to the memory interface circuit 1102 transmitting a job for PL0 of Bank 0 to the memory device 1200, the second managing module 1180 may increase the remaining time (0 μs) in the first row and first column (Bank 0, PL0) in the example of the remaining time information 1168 illustrated in FIG. 8C by the expected performance time of the transmitted job.

The memory controller 1100 (or the second managing module 1180) may update the remaining time information 1168 at every predetermined time period (e.g., 2 microseconds) so that the remaining time of each of the plurality of planes included in the remaining time information 1168 is reduced by the predetermined time period (except for when the remaining time is zero). That is, the memory controller 1100 may manage the remaining time of each of the plurality of planes even if the memory controller 1100 does not receive information associated with an actual remaining time from the memory device 1200.

The memory controller 1100 (or the second managing module 1180) may use the remaining time information 1168 to calculate the third bitmap 1166. For example, from the remaining time information 1168, the number of planes with non-zero remaining time may be calculated for each of the plurality of banks (Banks 0 to 3), and this may be used to calculate the third bitmap 1166.

In addition, because the memory controller 1100 (or the second managing module 1180) updates the remaining time information 1168 at every predetermined time period, the memory controller 1100 (or the second managing module 1180) may, in response to a remaining time of a specific plane changing to zero, change the bit in the third bitmap 1166 indicating the number of planes for which there is a running job in the bank that includes the specific plane whose remaining time is changed to zero. For example, in response to the change of the remaining time of PL1 of Bank 0 to zero after five microseconds from acquiring the remaining time information 1168 illustrated in FIG. 8C, the bit corresponding to Bank 0 of the Plane 3ea area in the third bitmap 1166 may be changed to “0”, and the bit corresponding to Bank 0 of the Plane 2ea area may be changed to “1”.

FIG. 9 is a diagram illustrating the operation S630 of FIG. 6 in detail. The memory controller (e.g., the memory controller 1100 of FIG. 1) may acquire, for each of the plurality of banks at a specific point in time, the first plane information indicating the first number of planes for which there is a pending (or, waiting) job in the memory controller, at S631. The first plane information may be acquired based on the first bitmap 1162 and/or the second bitmap 1164 of FIG. 8A.

The memory controller 1100 may acquire, for each of the plurality of banks at a specific point time, the second plane information indicating the second number of planes for which there is a job in progress in the memory device, at S632. The second plane information may be acquired based on the third bitmap 1166 and/or the remaining time information 1168 of FIG. 8A.

The memory controller 1100 may determine a target bank based on the first number of planes and the second number of planes of each of the plurality of banks.

For example, the memory controller 1100 may calculate, from the first plane information and the second plane information of S631 and S632, a sum of the first number of planes and the second number of planes for each of the plurality of banks, and determine whether there are two or more banks having the largest sum of the first number of planes and the second number of planes, at S633. For example, referring to the examples of the second bitmap 1164 and the third bitmap 1166 illustrated in FIGS. 8B and 8C, the sums of the first number of planes and the second number of planes of Banks 0 to 3 may be (0+3)=3, (1+3)=4, (2+2)=4, and (1+0)=1, respectively. In this case, because the sums of the first number of planes and the second number of planes are equal to each other and the largest in Banks 1 and 2, the memory controller 1100 may determine that there are two or more banks having the largest sum of the first number of planes and the second number of planes, which are Banks 1 and 2.

If there is only one bank having the largest sum of the first number of planes and the second number of planes, the memory controller 1100 may determine the bank having the largest sum of the first number of planes and the second number of planes to be the target bank, at S634.

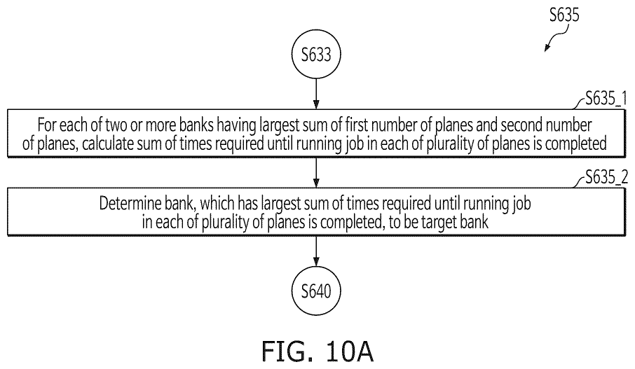

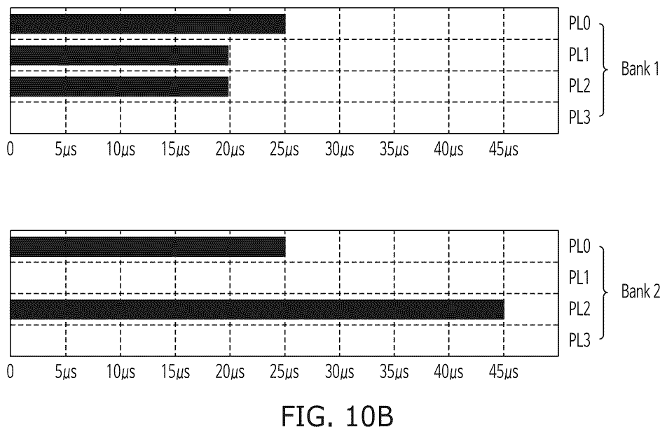

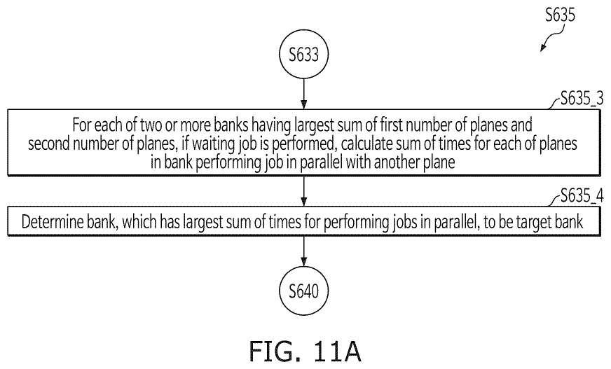

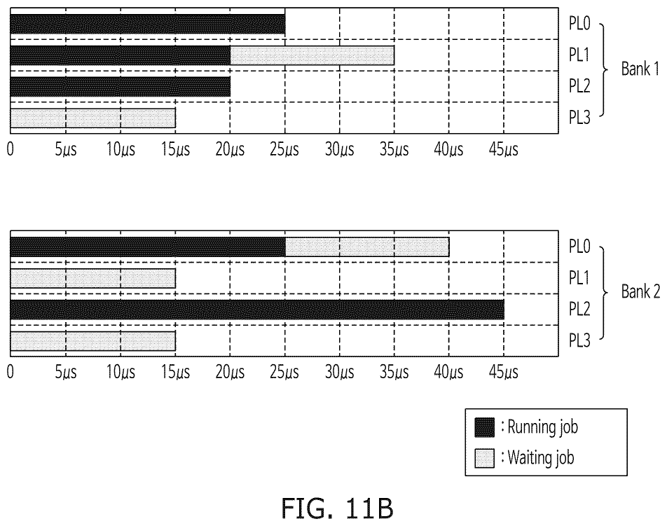

On the other hand, if there are two or more banks having the largest sum of the first number of planes and the second number of planes, the memory controller 1100 may determine one of the two or more banks with the largest sum of the first number of planes and the second number of planes to be the target bank, at S635. For example, the memory controller 1100 may determine a priority of each of the two or more banks having the largest sum of the first number of planes and the second number of planes, and determine the bank having the highest determined priority to be the target bank. This will be described in detail below with reference to FIGS. 10A to 11B.

FIG. 10A is a diagram illustrating the operation S635 of FIG. 9 in detail, and FIG. 10B is a diagram visualizing the remaining times of the running jobs in the planes of some banks (Bank 1, Bank 2). In the operation S633 illustrated and described with reference to FIG. 9, it is assumed that it is determined that there are Bank 1 and Bank 2 of FIG. 10B as the banks having the largest sum of the first number of planes and the second number of planes. The remaining time visualized in FIG. 10B corresponds to the remaining time information 1168 of FIG. 8C.

The memory controller 1100 may calculate, for each of the two or more banks having the largest sum of the first number of planes and the second number of planes, a sum of times (remaining times) required until the running job in each of the plurality of planes is completed, at S635_1. The sum of times (remaining times) required until the running job in each of the plurality of planes is completed may be calculated using the remaining time information 1168 of FIG. 8A.

For example, referring to the example of FIG. 10B, the times (remaining times) required until a job is completed in each of the plurality of planes (PL0 to PL3) of Bank 1 may be 25 microseconds, 20 microseconds, 20 microseconds, and 0, respectively, and the sum of times may be calculated as 65 microseconds. Similarly, the times (remaining times) required until the job is completed in each of the plurality of planes (PL0 to PL3) of Bank 2 may be 25 microseconds, 0, 45 microseconds, and 0, respectively, and the sum of times may be calculated as 70 microseconds.

The memory controller 1100 may determine a bank, which has the largest sum of times required until the running job in each of the plurality of planes is completed, to be the target bank, at S635_2. That is, the memory controller 1100 may give a higher priority to a bank having the largest sum of times required until the running job in each of the plurality of planes is completed, and determine the bank with the highest priority to be the target bank. For example, in the example of FIG. 10B, because the sum of times required in Bank 2, that is, 70 microseconds, is greater than the sum of times required in Bank 1, that is 65 microseconds, the memory controller 1100 may determine that Bank 2 has a higher priority and determine Bank 2 to be the target bank. That is, the memory controller 1100 may determine a bank, which is expected to have a high degree of overlap in the job performance time of each of the planes, to be the target bank and transmit a job to the determined target bank, which may optimize and reduce the power consumption of the that bank compared to when there is no overlap or a low degree of overlap in the job performance time of each of the planes.

FIG. 11A is a diagram illustrating the operation S635 of FIG. 9 in detail according to another aspect, and FIG. 11B is a diagram visualizing the remaining time of the running job in the planes of some banks (Bank 1, Bank 2) and expected performance time of the waiting jobs. In the operation S633 illustrated and described with reference to FIG. 9, it is assumed that it is determined that Bank 1 and Bank 2 of FIG. 10B are the banks having the largest sum of the first number of planes and the second number of planes.

Referring to FIGS. 11A and 11B, for each of two or more banks having the largest sum of the first number of planes and the second number of planes, if waiting jobs are performed, the memory controller 1100 may calculate a sum of times for each of the plurality of planes in the bank performing the jobs in parallel with other planes, at S635_3. The sum of times may correspond to a sum of parallel times (i.e., the time that two bars overlap in FIG. 11B for any two planes) for all possible combinations of two planes in the bank. The sum of times may be determined for each of all banks, and the bank with the largest result may be identified as the target bank.

For example, if it is assumed that waiting jobs in the memory controller 1100 for Banks 1 and 2 are transmitted to Banks 1 and 2 to be performed as in the example illustrated in FIG. 11B. In this example, there are six possible combinations of two planes for each bank, (PL0, PL1), (PL0, PL2), (PL0, PL3), (PL1, PL2), (PL1, PL3), and (PL2, PL3). The sum of times for Bank 1 performing jobs in parallel may be 110 microseconds, which is the sum of 25 microseconds for performing jobs in parallel between PL0 and PL1 (i.e., the time that the bars corresponding to PL0 and PL1 in Bank 1 overlap), 20 microseconds for performing jobs in parallel between PL0 and PL2 (i.e., the time that the bars corresponding to PL0 and PL2 in Bank 1 overlap), 15 microseconds for performing jobs in parallel between PL0 and PL3 (i.e., the time that the bars corresponding to PL0 and PL3 in Bank 1 overlap), 20 microseconds for performing jobs in parallel between PL1 and PL2 (i.e., the time that the bars corresponding to PL1 and PL2 in Bank 1 overlap), 15 microseconds for performing jobs in parallel between PL1 and PL3 (i.e., the time that the bars corresponding to PL1 and PL3 in Bank 1 overlap), and 15 microseconds for performing jobs in parallel between PL2 and PL3 (i.e., the time that the bars corresponding to PL2 and PL3 in Bank 1 overlap).

The sum of times for performing jobs in parallel in Bank 2 may be 115 microseconds, which is the sum of 15 microseconds for performing jobs in parallel between PL0 and PL1, 40 microseconds for performing jobs in parallel between PL0 and PL2, 15 microseconds for performing jobs in parallel between PL0 and PL3, 15 microseconds for performing jobs in parallel between PL1 and PL2, 15 microseconds for performing jobs in parallel between PL1 and PL3, and 15 microseconds for performing jobs in parallel between PL2 and PL3.

The memory controller 1100 may determine a bank, which has the largest sum of times for performing jobs in parallel, to be the target bank, at S635_4. That is, the memory controller 1100 may give a higher priority to the bank having the largest sum of times for performing jobs in parallel, and determine the bank with the highest priority to be the target bank. For example, in the example of FIG. 11B, the sum of times for performing jobs in parallel in Bank 2, which is 115 microseconds, is greater than the sum of times for performing jobs in parallel in Bank 1, which is 110 microseconds, so Bank 2 has the highest priority and may be determined to be the target bank.

Alternatively, the memory controller 1100 may determine a target bank according to a degree of increase (e.g., amount of increase, rate of increase) in the sum of times for performing jobs in parallel based on the assumption that a waiting job in the memory controller 1100 is to be transmitted to the bank and performed, compared to the sum of times for performing jobs in parallel for running jobs. For example, when it is assumed that a waiting job for Bank 1 is to be transmitted to the bank and performed, the time for performing jobs in parallel increases by 50 microseconds, whereas, when it is assumed that a waiting job for Bank 2 is to be transmitted to the bank and performed, the time for performing jobs in parallel increases by 90 microseconds. Accordingly, Bank 2 with a higher increase in the sum of times may be determined to be the target bank.

That is, by determining a bank, which is expected to have a high degree of overlap in the job performance time of each of the planes, to be the target bank, and transmitting the job to the determined target bank, the power consumption of the that bank may be optimized and reduced compared to when there is no overlap or a low degree of overlap in the job performance time of each of the planes.

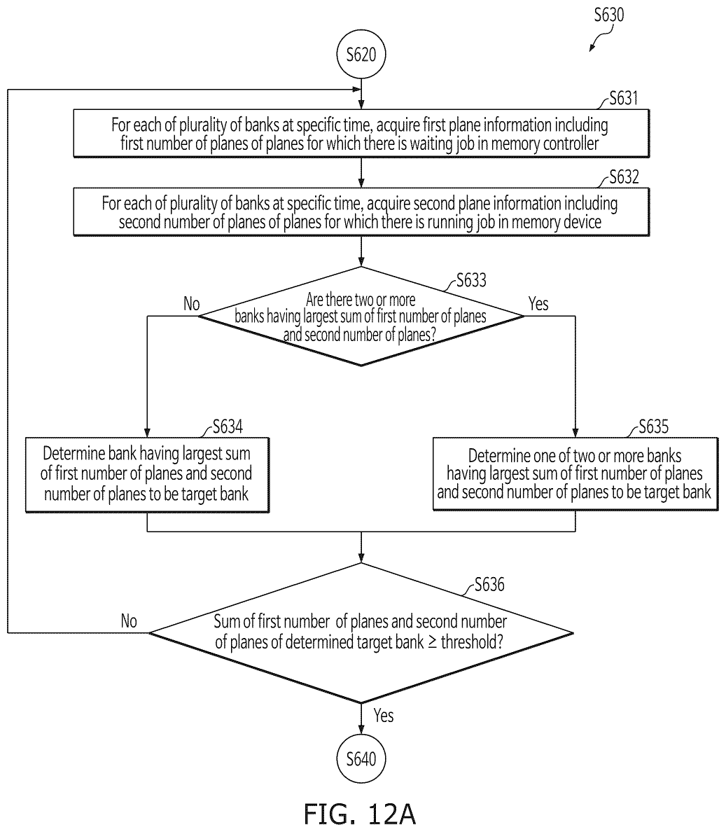

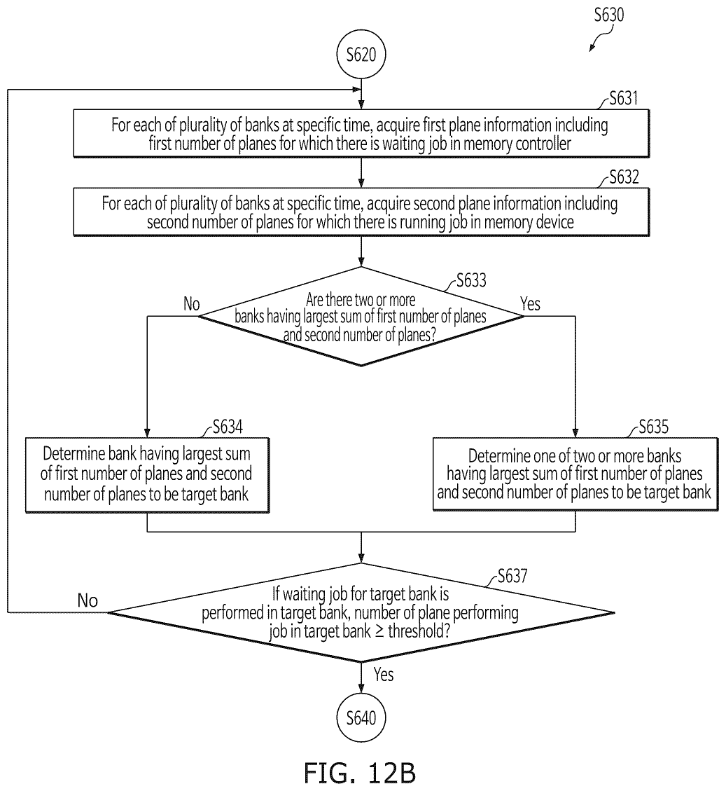

FIG. 12A is a flowchart provided to explain a modified example of the operation S630 of FIG. 9 according to some aspects, and FIG. 12B is a flowchart provided to explain a modified example of the operation S630 of FIG. 9 according to other aspects. The components described in S630 of FIG. 9 may be omitted from the description of FIGS. 12A and 12B.

Referring to FIG. 12A, the memory controller 1100 may determine whether the sum of the first number of planes and the second number of planes of the target bank is greater than or equal to a threshold (e.g., a predetermined threshold), at S636. In response to determining that the sum of the first number of planes and the second number of planes of the target bank is greater than or equal to the threshold, the memory controller 1100 may transmit a waiting job for the target bank to the memory device, at S640.

Otherwise, that is, in response to determining that the sum of the first number of planes and the second number of planes of the target bank is less than the threshold, the memory controller 1100 may perform operations S631 to S635 again at a following time.

For example, if the sum of the first number of planes and the second number of planes of the target bank determined at a first time is less than the threshold, the memory controller 1100 may calculate the sum of the first number of planes and the second number of planes for each of the plurality of banks at a second time subsequent to the first time, and determine the bank with the largest sum of the first number of planes and the second number of planes at the second time to be the target bank. In this case, the target bank determined at the second time may be the same as or different from the target bank determined at the first time.

In response to determining that the sum of the first number of planes and the second number of planes of the second bank is greater than or equal to the threshold at the second time, the memory controller 1100 may transmit a waiting job for the second bank at the second time to the memory device 1200.

That is, even if a job is transmitted to the target bank, if it is expected that there is no overlap or a low degree of overlap in the job performance time of each of the planes, the target bank may be re-determined based on the following time, so that the degree of overlap in the job performance time of each of the planes can be improved.

For example, referring to FIG. 12B, if a waiting job for the target bank is performed in the target bank, the memory controller 1100 may determine whether the number of planes performing the job in the target bank is greater than or equal to a threshold, at S637. For example, in the example illustrated in FIG. 11B, when it is assumed that a waiting job is transmitted to Bank 2, which is the target bank, the number of planes performing the job in the target bank may be determined to be four.

If the waiting job for the target bank is performed in the target bank, in response to determining that the number of planes performing the job in the target bank is greater than or equal to the threshold, the memory controller 1100 may transmit the waiting job for the target bank to the memory device, at S640.

Otherwise, that is, if the waiting job for the target bank is performed in the target bank, in response to determining that the number of planes performing the job in the target bank is less than the threshold, the memory controller 1100 may perform steps S631 to S635 again at the following time. For example, the memory controller 1100 may calculate the sum of the first number of planes and the second number of planes for each of the plurality of banks at a second time subsequent to the first time, and determine the bank with the largest sum of the first number of planes and the second number of planes at the second time to be the target bank. In this case, the target bank determined at the second time may be the same as or different from the target bank determined at the first time.

If a waiting job for the second bank is performed in the second bank at the second time, in response to determining that the number of planes performing the job in the second bank is greater than or equal to the threshold, the memory controller 1100 may transmit the waiting job for the second bank at the second time to the memory device 1200.

That is, even if a job is transmitted to the target bank, if it is expected that there is no overlap or a low degree of overlap in the job performance time of each of the planes, the degree of overlap in the job performance time of each of the planes may be improved by re-determining the target bank based on the following time.

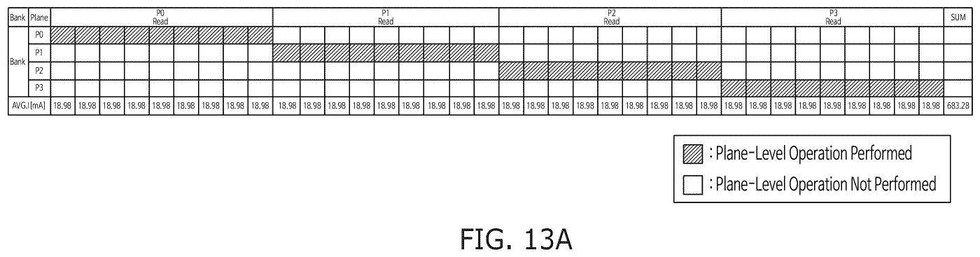

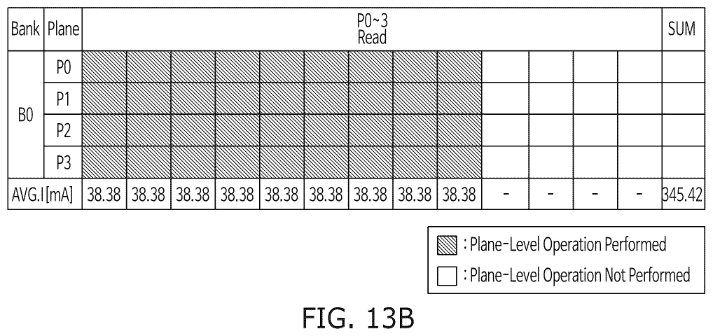

FIG. 13A is a diagram illustrating an amount of current consumed when there is one plane performing a job in each time unit in a single bank, and FIG. 13B is a diagram illustrating an amount of current consumed when there are four planes performing a job in each time unit in a single bank.

The jobs performed in FIGS. 13A and 13B are the same, and AVG.I values at the bottom of the table represents the amounts of current consumed in each time unit. The example of FIG. 13A shows an amount of current consumed when there is no overlap in the job performance time between planes, and the example of FIG. 13B shows an amount of current consumed when there is a maximum overlap in the job performance time between planes.

In the example of FIG. 13A, the amount of current consumed in each time unit in the bank is measured to be about 18.98 mA, whereas in the example of FIG. 13B, the amount of current consumed in each time unit in the bank is measured to be about 38.38 mA. That is, in FIG. 13B, the average amount of current consumed for processing the same amount of jobs as in FIG. 13A during one time unit may be calculated to be 38.38 mA/4. In addition, the total amount of current consumed in the example of FIG. 13A is measured to be 683.28 mA, whereas the total amount of current consumed in the example of FIG. 13B is measured to be 345.42 mA. In summary, the amount of current consumed in the example of FIG. 13B is reduced to about 51% compared to the example of FIG. 13A.

That is, as the number of planes performing the job at the same time increases, the amount of current consumed may decrease relative to the amount of jobs performed. Therefore, according to various aspects, by increasing the number of planes performing the job at the same time, the power consumption of the memory device may be optimized or reduced.

One or more operations in the process illustrated and described with reference to the flowcharts may be omitted, the order of each of the operations may be changed, one or more operations may be temporally overlapped, or one or more operations may be repeatedly performed several times.

In some embodiments, each of the components represented by a block as illustrated in FIGS. 1, 2, 6B, 7 and 8A may be implemented as various numbers of hardware and/or firmware structures that execute respective functions described above, according to example embodiments. For example, at least one of these components may include various hardware components including a digital circuit, a programmable or non-programmable logic device or array, an application specific integrated circuit (ASIC), transistors, capacitors, logic gates, or other circuitry using use a direct circuit structure, such as a memory, a processor, a logic circuit, a look-up table, etc., that may execute the respective functions through controls of one or more microprocessors or other control apparatuses. Also, at least one of these components may further include or may be implemented by a processor such as a central processing unit (CPU) that performs the respective functions, a microprocessor, or the like. Functional aspects of example embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of example embodiments have been particularly shown and described, it will be understood that various changes in form and details may be made therein without departing from the spirit and scope of the following claims.

What is claimed is:

1. A storage device, comprising:
a memory device comprising a plurality of planes, wherein each of the plurality of planes is provided in one of a plurality of banks of the memory device; and
a memory controller configured to:
receive, from a host, a plurality of jobs to be performed on the memory device, the plurality of jobs comprising a plane-level job to be performed in a plane from among the plurality of planes;
determine, for each of the plurality of planes at a first time, a target bank from among the plurality of banks based on plane information associated with a job from among the plurality of jobs that is pending in the storage device; and
transmit the job for the target bank to the memory device.

2. The storage device of claim 1, wherein the plane information comprises:
for each of the plurality of banks, first plane information indicating a first number of planes for which there is a waiting job in the memory controller; and
for each of the plurality of banks, second plane information indicating a second number of planes for which there is a running job in the memory device, and
wherein the memory controller is further configured to determine the target bank based on the first number of planes and the second number of planes of each of the plurality of banks.

3. The storage device of claim 2, wherein the memory controller is further configured to determine, among the plurality of banks, a first bank having a largest sum of the first number of planes and the second number of planes to be the target bank.

4. The storage device of claim 3, wherein the memory controller is further configured to transmit to the memory device, in response to determining that a sum of the first number of planes and the second number of planes of the first bank is greater than or equal to a threshold, a waiting job for the first bank at the first time.

5. The storage device of claim 4, wherein the memory controller is further configured to:
identify, in response to determining that the sum of the first number of planes and the second number of planes of the first bank is less than the threshold, a subsequent sum of the first number of planes and the second number of planes for each of the plurality of banks at a second time subsequent to the first time;
determine, among the plurality of banks, a second bank having a largest sum of the first number of planes and the second number of planes at the second time to be the target bank; and
transmit to the memory device, in response to determining that the subsequent sum of the first number of planes and the second number of planes of the second bank is greater than or equal to the threshold at the second time, a waiting job for the second bank at the second time.

6. The storage device of claim 3, wherein the memory controller is further configured to determine a sum of the first number of planes and the second number of planes for each of the plurality of banks based on a first bitmap indicating a number of planes for which there is the waiting job for each of the plurality of banks, and a second bitmap indicating a number of planes for which there is the running job for each of the plurality of banks.

7. The storage device of claim 6, wherein the memory controller is further configured to determine the first bitmap using a third bitmap that comprises a plurality of bits corresponding to the plurality of planes, and wherein the third bitmap indicates each of the plurality of planes for which there is a waiting job.

8. The storage device of claim 7, wherein the memory controller is further configured to update, in response to receiving the plane-level job from the host, at least a part of the first bitmap and at least a part of the third bitmap that are associated with the plane to perform the received job.

9. The storage device of claim 7, wherein the memory controller is further configured to:
transmit a waiting job to the memory device; and
update, in response to transmitting the waiting job to the memory device, at least a part of the first bitmap and at least a part of the third bitmap that are associated with a plane to perform the waiting job.

10. The storage device of claim 6, wherein the memory controller is further configured to update, in response to transmitting the plane-level job to the memory device, a part of the second bitmap associated with the plane.

11. The storage device of claim 3, wherein the first bank comprises a plurality of first planes,
wherein the plurality of banks comprises a second bank comprising a plurality of second planes,
wherein a sum of the first number of planes and the second number of planes of the second bank is the same as the sum of the first number of planes and the second number of planes of the first bank, and
wherein the memory controller is further configured to determine, in response to determining that a priority of the first bank is higher than a priority of the second bank, the first bank to be the target bank.

12. The storage device of claim 11, wherein the memory controller is further configured to:
identify a first sum of times required until a running job in each of the plurality of first planes is completed;
identify a second sum of times required until a running job in each of the plurality of second planes is completed; and
determine, based on the first sum being greater than the second sum, that the priority of the first bank is higher than the priority of the second bank.

13. The storage device of claim 12, wherein the memory controller is further configured to:
store remaining time information indicating a remaining time until the running job in each of the plurality of planes is completed;
update, in response to transmitting a job to the memory device, the remaining time information by increasing a remaining time of a plane performing the transmitted job by an expected performance time of the transmitted job; and
identify, based on the remaining time information, the first sum and the second sum.

14. The storage device of claim 13, wherein the memory controller is further configured to update the remaining time information at every predetermined time period by reducing the remaining time of each of the plurality of planes included in the remaining time information by the predetermined time period.

15. The storage device of claim 11, wherein the memory controller is further configured to:
identify, if a waiting job for the first bank is performed in the first bank, a first sum of times for each of the plurality of first planes performing a job in parallel with another first plane included in the first bank;
identify, if a waiting job for the second bank is performed in the second bank, a second sum of times for each of the plurality of second planes performing a job in parallel with another second plane included in the second bank; and
determine, in response to determining that the first sum is greater than the second sum, that the priority of the first bank is higher than the priority of the second bank.

16. The storage device of claim 1, wherein the memory controller is further configured to transmit, if a waiting job for the target bank is performed in the target bank, in response to determining that a number of planes performing the job in the target bank is greater than or equal to a threshold, the waiting job for the target bank to the memory device.

17. The storage device of claim 1, wherein the memory device is configured to:
perform the plurality of jobs in the plurality of banks; and
transmit, to the memory controller, data generated by performing the plurality of jobs to the host.

18. The storage device of claim 1, wherein the plane-level job is a read job, a write job, or an erase job.

19. A memory controller, comprising:
a memory interface circuit connected to a memory device comprising a plurality of planes, wherein each of the plurality of planes is provided in one of a plurality of banks of the memory device;
a host interface circuit connected to a host and configured to receive, from the host, a plurality of jobs to be performed on the memory device, the plurality of jobs comprising a plane-level job to be performed in a plane within the memory device; and
a processor connected to the memory interface circuit and the host interface circuit, wherein the processor is configured to:
determine, for each of the plurality of planes at a specific time, one of the plurality of banks to be a target bank based on plane information associated with a job pending in the memory device or the memory controller; and
transmit, among the plurality of jobs that are waiting in the memory controller, a waiting job for the target bank to the memory device through the memory interface circuit.

20. A method for operating a storage device, the method being performed by a memory controller and comprising:
receiving a plurality of jobs to be performed on a memory device, the plurality of jobs comprising a plane-level job to be performed in a plane from among a plurality of planes of the memory device, wherein each of the plurality of planes is included in one of a plurality of banks of the memory device;
determining, for each of the plurality of planes at a specific time, one of the plurality of banks to be a target bank based on plane information associated with a job pending in at least one of the memory device or the memory controller; and
transmitting, among the plurality of jobs that are waiting in the memory controller, a waiting job for the target bank to the memory device.
